(19) United States
(12) Patent Application Publication
(10) Pub. No.: US 2008/0301188 A1
(43) Pub. Date: Dec. 4, 2008

(54) METHOD AND SYSTEM TO TRACK ACCOMPLISHMENTS AND TO COMPUTE RELATIVE RANKINGS

(76) Inventor: Daniel P O'Hara, Cumming, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/757,751

(22) Filed: Jun. 4, 2007

Related U.S. Application Data
(60) Provisional application No. 60/803,868.

(51) Int. Cl. G06F 17/30

(52) U.S. Cl. 707/104.1; 707/E17.005

(57) ABSTRACT

A system and method for listing activities within particular categories. Activities that are accomplished/achieved by respective users can be tracked and stored in a database. Accomplishments of users can be compared against accomplishments of other users and achievement levels can be computed and outputted. Achievement scores can also be calculated for each user. Activities can be associated with particular categories (e.g., “scuba diving.”) Particular categories can be associated with general categories (e.g., “sports.”) Users are permitted to contribute to and modify the activities and/or particular categories and/or general categories. Each user can record their own accomplishments against the list including information specific to that activity such as dates, location and attributes using a computer connected to a computer communications network such as the Internet. The user can compare his or her accomplishments against predefined thresholds related to a number and type of activities accomplished, or other users or user maintained accomplishment lists. As a user's accomplishments grow past the achievement thresholds the user will be granted awards to acknowledge his or her achievements.

### CROSS REFERENCE TO RELATED APPLICATIONS

This application claims benefit to provisional application 60/803,868, which is incorporated by reference herein in its entirety.

### BACKGROUND OF THE INVENTION

1. Field of the Invention

The present inventive concept relates to a system, method, and computer readable storage medium to implement a method that can receive and store accomplishments among users and compute relative rankings among the users based on their respective accomplishments.

2. Description of the Related Art

Individuals have tracked their progress against list of activities and goals mentality and on paper for many years. Businesses and individuals have compiled lists of activities to allow individuals to view the entire list of activities related to a category or a ranked list of activities for a category. The Internet has provided means for lists to be published, reviewed and maintained by multiple individuals all over the globe.

However, what is needed is a system or method for allowing individuals to record their accomplishments against an activity list within multiple categories and for the system to calculate achievement levels for the user's accomplishments and identify achievement thresholds for the purposing of recognizing the user's accomplishments. What is also needed is a way an individual to compare their accomplishments against other users or predefined accomplishment lists.

### SUMMARY OF THE INVENTION

It is an aspect of the present invention to provide an improved way to compare a user's accomplishments among other users.

The above aspects can also be obtained by a method that includes (a) receiving and storing in a database users and each respective user's respective achievements; (b) determining a number of completed achievements for a particular user; (c) computing a score for the particular user based on the number of completed achievements and at least one bonus; (d) calculating a rank of the particular user against other users using the score for the particular user and respective scores for the other users; and (e) outputting to the user an output based on the rank.

The above aspects can also be obtained by method that includes (a) receiving and storing users and each respective user's respective achievements; (b) computing a rank for a particular user based on the particular user's achievements compared with other users' respective achievements; and (c) outputting an achievement level of the particular user based on the rank.

The above aspects can also be obtained by an apparatus that includes (a) an interface to receiving and store in a database users and each respective user's respective achievements; (b) a processing unit to perform: determining a number of completed achievements for a particular user; computing a score for the particular user based on the number of completed achievements and at least one bonus; calculating a rank of the particular user against other users using the score for the particular user and respective scores for the other users; and (c) an output device to output to the user an output based on the rank.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a simplified schematic block diagram that shows a general structure of users accessing the system via a computer on-line network such as the Internet, according to an embodiment;

FIG. 2 is a combined flowchart/block diagram illustrating an overall system flow diagram that illustrates the sequence of data access a user follows to access information, according to an embodiment;

FIG. 3A is a sample output illustrating a screen which allows the user to select a category, according to an embodiment;

FIG. 3B is a sample output illustrating a screen which allows the user to select activities within a category that they have accomplished, according to an embodiment;

FIG. 4 is a sample output illustrating a screen which allows the user to see details about an activity and to enter accomplishment information, according to an embodiment;

FIG. 5 is a flowchart illustrating a method to calculate accomplishment scores and achievement levels, according to an embodiment;

FIG. 6A is a sample output illustrating a screen which displays the computed achievement level for a user, according to an embodiment;

FIG. 6B is a sample output illustrated a screen which displays the computed achievement comparison for a user, according to an embodiment; and

FIG. 7 is a block diagram illustrating hardware that can be used to implement methods described herein, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present general inventive concept relates to a system, method, and computer readable storage medium that enables a user to review a list of activities based on a desired category of interest (a particular category) and record which of the activities have been accomplished (or achieved) by the user, which become the user's accomplishments (or achievements). The system can then calculate a user's respective raw score related to the user's accomplishments and can also calculate bonus scores which consider the user's specific accomplishments and potentially other users' accomplishments as well. The system will determine achievement levels based on the scores and will allow the user to compare their scores to other users of the system.

Another aspect of the method of the present invention is to allow the user to review the list of activities and suggest new activities that apply to the category of interest. Depending on the category and system set up the activities may be automatically added or placed in a pending state for a system moderator to review and approve.

A user interface organizes information into a consistent presentation of menu selections and categorically organized information. Furthermore, at specified levels of the categorical organized information, the user is presented with the option of accessing a list of activities related to that category, wherein the activities are defined by the users of the system. The user interacts with the activities in the list by adding their personal accomplishments related to the activity. The user interacts with a web browser by choosing among menu selections using standard point-and-click techniques. The web browser of the preferred embodiment translates the user's current menu selections into either a set of queries against the list of activities, or a set of web pages that allow the user to interact with the system to add additional information to the system. The user is presented with the option to view their achievement levels, which causes the system to execute its calculations and algorithms to determine the users achievement points and achievement levels.

The system can comprises a computer network wherein a plurality of computers has access to the computer network and an organizer (or server) running in the computer network. The system can be configured to receive requests from any one of the plurality of computers. The system comprises a database of information which can be, in an embodiment, organized by activity category and user's accomplishments. The information corresponding to each one of the categories has its own specific attributes for the activities and accomplishments allowing for the information to be category specific.

The system can further comprise an achievement calculation engine in communication with the database. The achievement calculation engine is configured to tabulate a user's accomplishments against the list of activities and further perform bonus calculations and comparison calculations to determine the user's achievement level. Finally, the achievement calculation engine is configured to determine the user attainment of predefined achievement levels and positions relative to other users of the system.

In another embodiment, any information outputted can match a display format of remotely accessible information in an on-line network. The system further comprises a database (such as an SQL based database) which stores the remotely accessible information and a plurality of display formats. The remotely accessible information can be organized (either actually or virtually) into categories of activities and user accomplishments. The system can also comprise a display page generator in communication with the database and the user computer. The display page generator is configured to merge a portion of the remotely accessible information with one of the display formats to generate a display page which is communicated to the user computer.

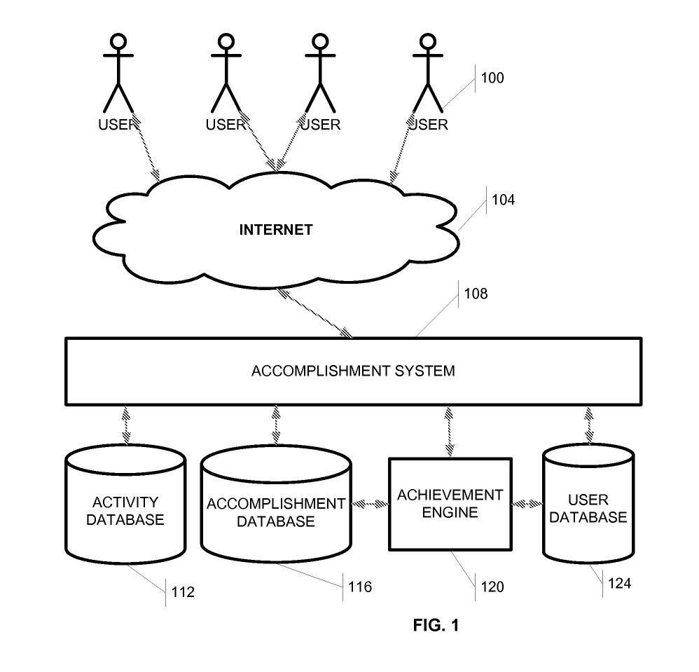

FIG. 1 is a simplified schematic block diagram that shows a general structure of users accessing the system via a computer on-line network such as the Internet 104 (or other computer communications network). Multiple users 100 can access the accomplishment system 108 via communicating over the Internet 104. The users may access the Internet by numerous devices including personal computers, mobile phones and Internet kiosks. By accessing the accomplishment system 108 the multiple users 100 can be presented with a series of web pages described in the following figures to access the activity database 112 which contains categorized lists of activities. The multiple users 100 can each navigate through the accomplishment systems menus and web pages to add their specific accomplishments to the accomplishment database 116. The accomplishments can be stored with links to the associated activity in the activity database and include the user that entered the accomplishment. The accomplishment system can communicate with the achievement engine 120 to calculate the user's achievement level and any thresholds they have crossed to earn awards. The achievement information is stored in the user database 124.

Note that all of the components described herein (e.g., activity database 112, accomplishment database 116, achievement engine 120, and user databases 124) do not necessarily need to exist separately and can exist on a single (or multiple servers). For example all of the databases can exist on a single database or two databases or spread throughout a distributed database system comprising many separate databases. The physical structure of the system described herein can be accomplished in an almost infinite number of ways and it can be appreciated that the methods described herein are not limited to being implemented on particular physical configurations.

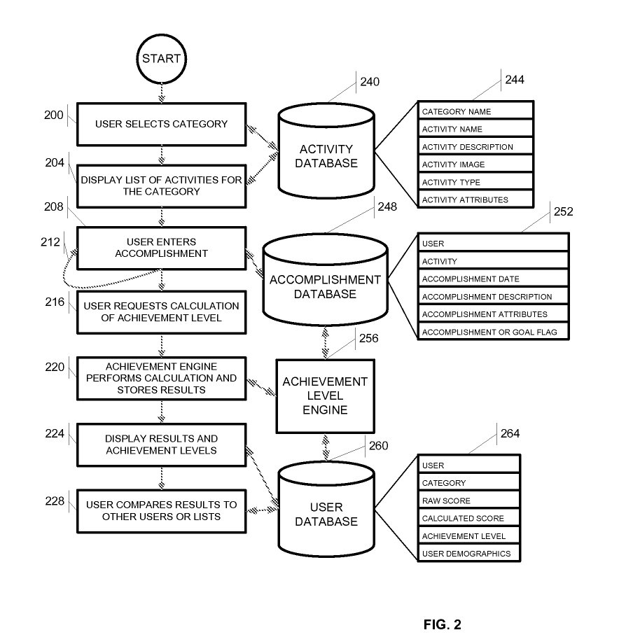

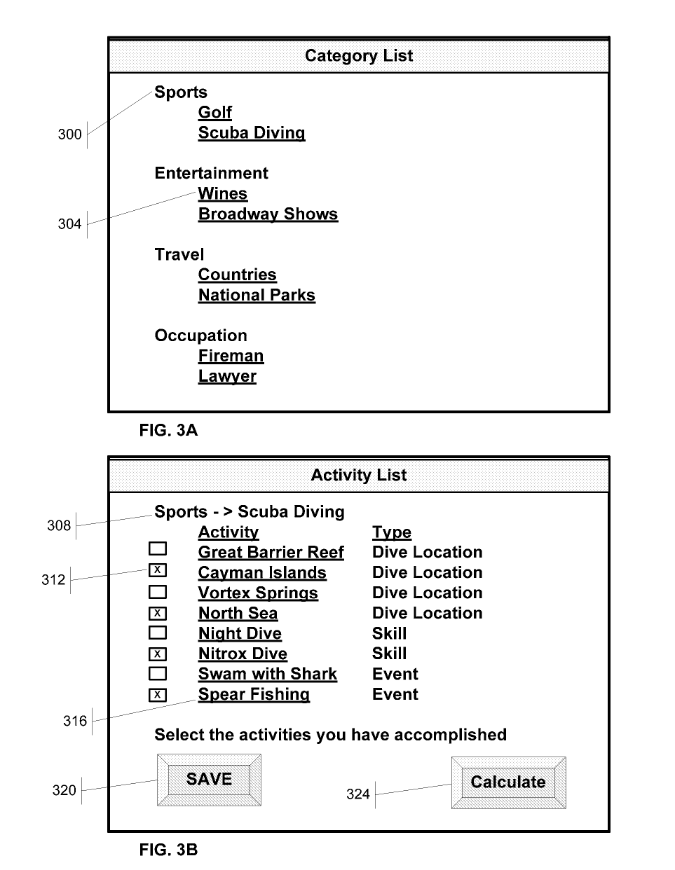

FIG. 2 is a combined flowchart/block diagram illustrating how the user interacts with the accomplishment system in FIG. 1. in order to review the categories and activities and enter their own accomplishments. It is assumed that the user has already navigated to the accomplishment system's main web page via a link or search engine (e.g., typed in a particular url in a web browser). The first operation 200 allows the user to select which particular category the user is interested in from a list of general categories retrieved from the activity database 240. FIG. 3A illustrates a list of general categories and their respective particular categories. For example, “sports” is a general category and “golf” and “scuba diving” are particular categories which are associated with the general category “sports.”

In operation 204, the system then displays a list of activities related for the particular category selected from FIG. 3A. The list of activities can be stored in the activity database 240 and includes attributes of the activity including the activity's name, description, image, type and category specific activity attributes as shown in data layout (or data structure or example fields) 244. See FIG. 3B for an example of an output of operation 204. The general category of “sports” is displayed with its particular category of “scuba diving” which is displayed with its respective activities.

From operation 204, the method can proceed to operation 208, wherein the user is able to enter accomplishments associated with any of the activities. The user can enter his or her accomplishments using standard graphical user interface (GUI) techniques, such as using a mouse to click checkboxes to select particular activities and actions. The accomplishments can be stored in the accomplishment database 248 including the accomplishments date, description, category specific accomplishment attributes, and any other related information as shown in data layout 252. The user can add additional accomplishments against the list of activities as is indicated by arrow 212.

After adding any number of accomplishments the process moves to operation 216, wherein the user can request the calculation of their achievement level.

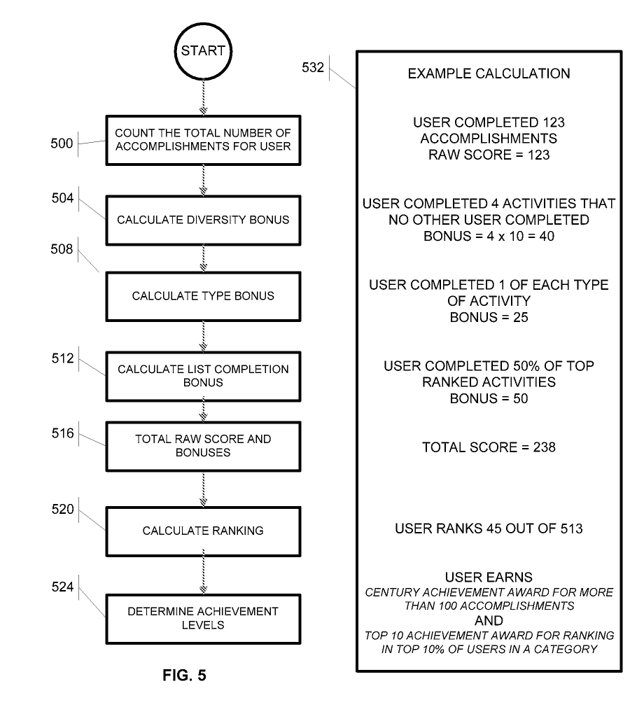

From operation 216, the method proceeds to operation 220 wherein the method calculates the achievement level for the user by calling the achievement level engine 256 which accesses the accomplishment database (or other database) to calculate the raw scores and bonus scores for the user to determine the user's (and possibly other users' as well) achievement levels. This process is illustrated in more detail in FIG. 5. The achievement engine can store the results of the calculations in the user database 260 including the user, category selected, raw score, calculated score, achievement level as well as user demographics such as age and gender as shown in data layout (or data structure or sample fields) 264.

The method then continues to operation 224 in which the system displays and output such as the result(s) of the calculations including the raw score for the number of accomplishments completed, the bonuses awarded and ranking. Achievement levels can also be determines based on predetermined criteria. For example, an “excellent” achievement level can be awarded to users who rank in the top X % of all users (e.g., 10%). A “terrific” achievement level can be awarded to users to have total scores (raw scores+bonus scores) between a certain range (e.g., 100-150). A “century” achievement level can be awarded to users that have achieved more than 100 (or any number) of accomplishments. Any value(s) described herein associated with a user can be used as a basis to determine which (if any) achievement level is to be awarded to that user, typically if the value(s) fall within a particular range or exceed a particular value.

The method can then proceed to operation 228 which compares the user's results with other users of the system as an overall score and ranking or by user demographics such as all male users under age 50. Results of the comparison can then also be output to the user.

It is noted that the order or operations illustrated in FIG. 2 (and any other figure herein) can be performed in any order. For example, operation 212 (and any other operation as well) can be returned to at any time in order for a user to add additional data (e.g., accomplishments).

FIG. 3A is a sample output illustrating a selection screen in which a user can view general categories and select the particular category they are interested in. The general categories are organized into logical groupings such as sports, entertainment, travel etc. as shown by 300. The particular categories are selected by the user clicking (e.g., by using a mouse, touch screen, etc.) on the categories name 304. In this example, the user selects the particular category of “scuba diving” in FIG. 3A. After selecting a particular category, the system displays an activity list screen FIG. 3B.

FIG. 3B is a sample output illustrating a screen which allows the user to select activities within a category that they have accomplished.

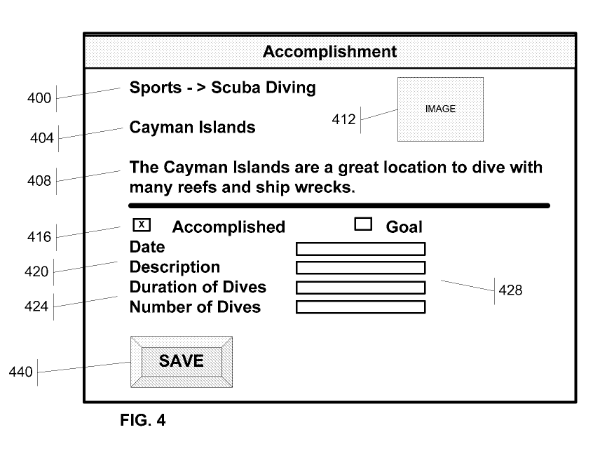

The activity list screen (in FIG. 3B) allows the user to indicate activities (which are accomplishments or achievements that the user can complete) that they have participated in which causes the system to store the achievement in the accomplishment database. The activity list screen shows the user which general category 308 “sports” they are entering accomplishments for, as well as the particular category “scuba diving.” The activities are displayed and the user can select which activities they have completed by “checking off the activity” in 312. After selecting the activities the user can save these accomplishments to the database by clicking a save button 320. The user can calculate their score at any time using a calculate button 324. This will cause the process described in FIG. 5 to be executed. The user can also get more detail on an activity by clicking on the hyperlink 316. By selecting the hyperlink the system will display the activity detail screen illustrated in FIG. 4.

FIGS. 3A and 3B correspond to what is performed in operation 208 of FIG. 2.

FIG. 4 is a sample output illustrating an accomplishment screen in which a user can enter detailed information on an accomplishment they have completed. The screen displays a general category 400 “sports,” a particular category “scuba diving” and an activity 404 the user has selected from FIG. 3B. The user can indicate that the user has achieved (completed) this particular activity in which the activity is stored in the database as an achievement (or accomplishment) for the user. The screen can also display activity specific information such as the activity description 408 and activity image 412. The user may enter information about the accomplishment including if it is an accomplishment or goal 416, the accomplishment date and description 420 and category specific accomplishment attributes 424 and respective attribute values 428. In this example the scuba diving category has the attributes “duration of dives” and “number of dives.” Another particular category such as golf would have different attributes such as the users golf score for the activity. The user can save the accomplishment by clicking a save button 440.

FIG. 5 is a flowchart illustrating how the achievement engine calculates the user's scores and achievement levels. The scores and achievement levels can be computed/determined for a particular category (e.g., “scuba diving”) which would include all activities associated with the particular category, or a combination of particular categories (which would include all of the activities associated with each of the particular categories). The scores and achievement levels can also be computed/determined for an entire general category (which include all of the activities for all particular categories associated with the general category), or for all general categories (which would include activities in all of the particular categories). The information used in the calculations can be stored in the accomplishment database as shown in FIG. 1.

In a first operation 500, the method counts the number of accomplishments the user has entered into the system (for example as illustrated in FIGS. 3A, 3B and 4). This can be considered the user's raw score.

In an example calculation 532 the user has entered 123 accomplishments. The achievement engine proceeds to the next operation 504 which calculates a diversity bonus. The diversity bonus is based on the uniqueness of their accomplishments against other users of the system. In the example calculation 532 the user completed four activities that no other user completed and the system calculates a bonus of 40 points (the number of activities that no other user ahs completed (i.e., 4) multiplied by a constant (i.e., 10).

The method can proceed to operation 508, which calculates a type bonus. The type bonus is calculated based on the number of different activity types that have been established for the particular category. The example calculation 532 shows the user has completed all of the activity types and the system calculates a bonus of 25 points. This is a bonus that is configurable by an operator of the system and the bonus point amounts can be set according to the operator's preferences. For example, the operator (system administrator) can set that any user that completes all of the activities in the particular category “scuba diving” will earn 25 points. Users that complete all activities in a different particular category (e.g., “wines,”) can earn 10 bonus points. If the user did not complete all activities in the particular category, then the user would not receive any type bonus at all for the particular category.

In the next operation 512, the method calculates a list completion bonus. For this category a list of top 10 ranked Scuba Dive locations is used to determine the list the user is measured against. The user has completed 50% or 5 of these accomplishments and the system calculates a bonus of 50 points.

In operation 516 the system calculates a total score by adding the raw score (computed in operation 500) and the bonuses (computed in operations 504, 508, 512)

In the next operation 520, the method calculates the ranking of the user against all other users of the system for this category. In the example the user's total score of 238 has placed them as the 45th highest score out of 513 users that have entered accomplishments for this particular category (e.g., “scuba diving”). Alternatively, the ranking can be computed for a general category (e.g., all particular categories falling within the general category), all general categories (e.g., all activities registered in the system), or a particular combination of general categories and/or particular categories (which can be set by a user or the system administrator).

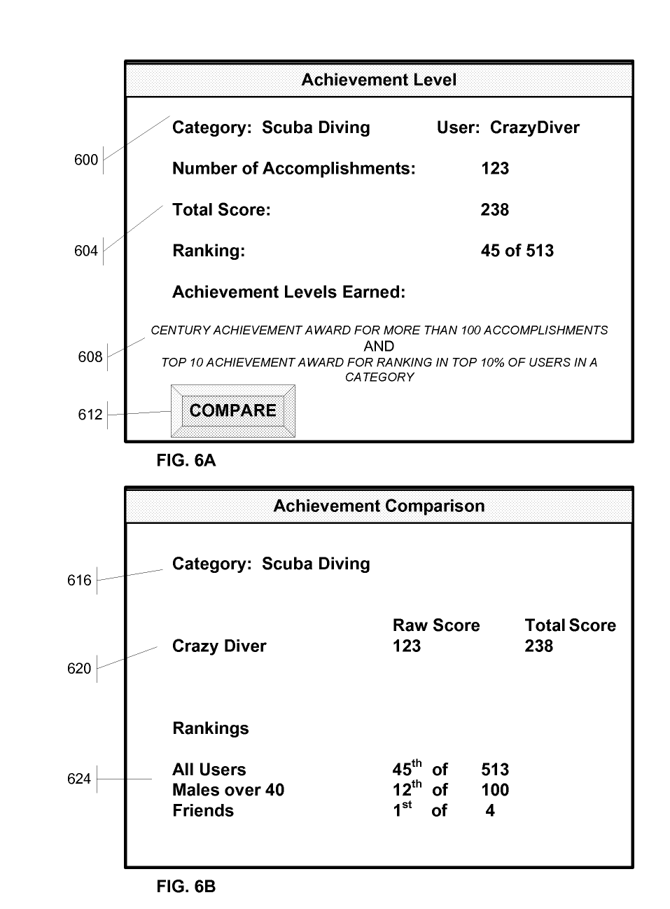

The method can proceed to operation 524, which determines the user's achievement levels. Based the example the user has completed over 100 accomplishments, calculated in 500, and ranks in the top 10% of the users in the particular category (“scuba diving”), calculated in 520. These two achievements are stored in the user database and can be displayed to the user in FIG. 6A.

FIG. 6A is a sample output illustrating a screen which displays the computed achievement level for a user (computed for example in operation 524), according to an embodiment. This can be displayed, for example, after the user has pressed the calculate button 324 from FIG. 3B.

The screen displays the particular category and user information 600, the number of completed accomplishments registered for the user, total score and ranking 604 as calculated by using the method illustrated in FIG. 5. The screen also displays the achievement levels earned 608. The user can compare their results to other users in the user database by clicking the compare button 612, which will cause the system to display FIG. 6B.

FIG. 6B is a sample output illustrated a screen which displays the computed achievement comparison for a user, according to an embodiment. The particular category used in the comparison is displayed in 616. The system displays the user's name, raw score and total score 620. The system also displays the users ranking(s) 624 as compared to the total number of users for the category, their demographic (in this example males over 40) and within a group of friends that the user has identified.

Further, the user can win awards or incentives (which can include prizes such as a free trip, monetary awards, etc.) based on the user's achievement level and/or rank. The awards can be paid for by a sponsor of the system and/or by the users themselves who will pay to participate.

A system administrator (or operator) can initialize the system and set all of the general categories, particular categories, activities, users, and any other field or information that the system can store/use.

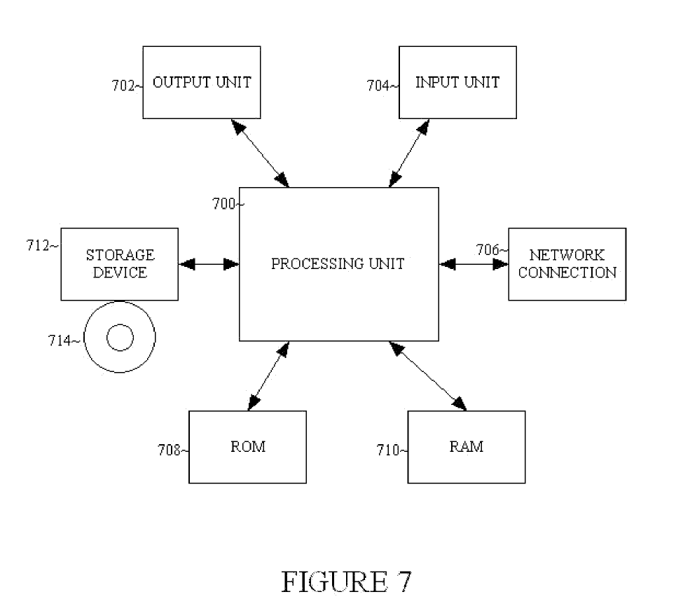

FIG. 7 is a block diagram illustrating hardware that can be used to implement methods described herein, according to an embodiment.

A processing unit 700 can be a microprocessor and any other associated hardware (e.g., cache, etc.). An output unit can be a monitor (such as an LCD, touch screen, etc.) An input unit can be any input device, such as a touch screen, computer mouse, keyboard, etc. A network connection 706 is a link to a computer communications network such as the Internet. A RAM 710 and a ROM 708 can be used as needed to implement the hardware and run any necessary instructions on the processing unit 700. A storage device 712 can load a computer readable storage medium 714 such as a CD-ROM, DVD, etc., which can store a program which can control a computer to perform any of the methods described herein.

Additionally, computer instructions may be implemented in a number of ways to effectuate the methods described herein, wherein the actual structure of the hardware and software used is not critical to the implementation of embodiments. Any alternative design approaches can be implemented. For example, the system of FIG. 1 may be formed alternatively in hardware or in a combination of hardware and software that is executed by a processor. As may be seen, the described embodiments may be modified in many different ways without departing from the scope or teachings of the invention. Furthermore, the display outputs described herein can accommodate any type of information formats which can be found, for example, on the Internet (e.g., html, XML, etc.) Any operations described herein can also be performed in any order.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A computer implemented method to compare accomplishments, the method comprising:
receiving and storing in a database users and each respective user's respective achievements;
determining a number of completed achievements for a particular user;
computing a score for the particular user based on the number of completed achievements and at least one bonus;
calculating a rank of the particular user against other users using the score for the particular user and respective scores for the other users; and
outputting to the user an output based on the rank.

2. The method as recited in claim 1, wherein the at least one bonus is a diversity bonus computed by determining a number of achievements that the particular user completed that no other user completed.

3. The method as recited in claim 1, wherein the at least one bonus is a type bonus computed based on a number of types of activities that the particular user completed.

4. The method as recited in claim 1, wherein the at lest one bonus is a type bonus computer by determining if the user has completed all activities of a particular category, and if so, then the type bonus is a predetermined number.

5. The method as recited in claim 1, wherein the at least one bonus is a list completion bonus computed by determining a number or percentage of achievements on a particular list that the user has completed.

6. The method as recited in claim 1, wherein the computing the score adds the number of completed achievements and the at least one bonus.

7. The method as recited in claim 1, wherein the output is the rank.

8. The method as recited in claim 1, wherein the output is an achievement level based on the rank.

9. The method as recited in claim 8, wherein the achievement level is a qualifier based on a predefined threshold or range that the rank falls within.

10. The method as recited in claim 1, wherein the achievements comprise attribute values.

11. The method as recited in claim 1, wherein the achievements are categorized as a subset of activities.

12. The method as recited in claim 11, wherein the activities are categorized as a subset of categories.

13. The method as recited in claim 11, wherein each activity comprises an activity description and a type of the activity.

14. The method as recited in claim 13, wherein the at least one bonus is a type bonus computed by determining a number of types of activities that the particular user completed.

15. The method as recited in claim 12, further comprising allowing the user to add additional categories.

16. The method as recited in claim 1, further comprising awarding to the user an award or incentive based on the rank.

17. A computer implemented method to compare accomplishments, the method comprising:
receiving and storing users and each respective user's respective achievements;
computing a rank for a particular user based on the particular user's achievements compared with other users' respective achievements; and
outputting an achievement level of the particular user based on the rank.

18. An apparatus to compare accomplishments, the apparatus comprising:
an interface to receiving and store in a database users and each respective user's respective achievements;
a processing unit to perform:
determining a number of completed achievements for a particular user;
computing a score for the particular user based on the number of completed achievements and at least one bonus;
calculating a rank of the particular user against other users using the score for the particular user and respective scores for the other users; and
an output device to output to the user an output based on the rank.
